(19) United States
(12) Patent Application Publication
(10) Pub. No.: US 2015/0314533 A1
(43) Pub. Date: Nov. 5, 2015

(54) PRINTING METHOD FOR THREE-DIMENSIONAL OBJECT AND SYSTEM THEREOF

(71) Applicants: INVENTEC APPLIANCES (PUDONG) CORPORATION, Shanghai (CN); INVENTEC APPLIANCES CORP., New Taipei City (TW); INVENTEC APPLIANCES (SHANGHAI) CO. LTD., Shanghai (CN)

(72) Inventors: Li YU, Shanghai (CN); Shih-Kuang TSAI, Shanghai (CN)

(21) Appl. No.: 14/540,570

(22) Filed: Nov. 13, 2014

(30) Foreign Application Priority Data
May 4, 2014 (CN) 201410184554.1

(51) Int. Cl. B29C 67/00

(52) U.S. Cl. CPC B29C 67/0088; B29C 67/0059; B33Y 10/00

(57) ABSTRACT

A printing method for a three-dimensional object and system thereof, the method includes: analyze and build a three-dimensional model of a work piece to be printed. Discrete three-dimensional model along the first axis into the two-dimensional multi-level, and get a second two-dimensional plane coordinate for the second axis and the third axis from each layer in two-dimensional layer. Each time will according to the second two-dimensional horizontal coordinate for the second axis and the third axis sequentially for a second two-dimensional coordinates of each layer of the work piece axis line by line dot matrix printing. The present invention can overcome the limitations of existing 3D printing printer, and to achieve a three-dimensional model of the single direction infinite print. Even smaller three-dimensional printer does not require changes to existing structures.

### FIELD OF THE INVENTION

The present invention relates to a printing method for three dimensional object and the system thereof, and in particular to three dimensional model of single axis direction infinite printing method and the system.

### BACKGROUND OF THE INVENTION

Three-dimensional (3D) print technology is actually a series of rapid prototyping collectively technology and the basic principles are laminated manufacturing. The rapid prototyping is scanned in the X-Y plane to form each layers of cross-sectional shape for work-piece as shown in FIG. 1 and is moved disconnectedly with bedding surface thickness in Z-axis so as to form a three-dimensional work piece. In FIG. 1, the desired filled 13 of work-piece is located between the outer boundary 11 and inner boundary. The rapid prototyping technology includes 3DP (three-dimensional printing and gluing), FDM (fused deposition modeling), SLA (Stereolithigraphy apparatus), SLS (selecting laser sintering), DLP (digital light processing), UV light modeling technology. The FDM is that the filaments of hot melt material being heated to melt, and the three-dimensional nozzle is controlled by the computer to selectively apply the material on the work table according to the cross-section profile information and after rapid cooling, a layer of cross-section surface is formed. After a layer is formed, the work machine will drop a height (the separated layer thickness) to form the next layer, until the solid modeling is formed completely. The molding material is various, the molded parts with high strength and high precision, and is mainly applied to small pieces of plastic molding.

Three-dimensional printers with 3DP technology utilizes standard inkjet print technology, by spreading the liquid connecting body on the powder thin layer, each parts and the three-dimensional solid model is created in a cross-sectional data printing manner step by step approach. The sample model is formed by using above manner with the same color as the actual products, and the color analysis results can also be painted directly on the model, such that the larger information of the model sample can be passed.

However, the size of the present three-dimensional printer will directly affect the actual size of the work piece is to be printed. For example, as shown in FIG. 2, when the cross-section shape of one layer of work piece is to be printed, the printing direction and sequence of the present three-dimensional printer is from a, b, c, d and e, and the printing scope is printed from outward to inward. The printing scope is limited in the inner space of the printer. Thus, the present three-dimensional printer is merely provided for printing limitation space and cannot be continuously feed paper to achieve the infinite printing as the paper printer.

### SUMMARY OF THE INVENTION

An objective of the present invention is to provide a three-dimensional model of single axis direction infinite printing method and the system so as to break the printing limitation of the three-dimensional printer to achieve the infinite printing for three-dimensional model.

To realize the above objective, the present invention provides a three-dimensional object printing method, which includes analyzing and constructing a three-dimensional model to be printed. The three-dimensional model is separated into a plurality of two-dimensional layers along a first axis direction to obtain two-dimensional horizontal coordinate of the plurality of two-dimensional layers which is constructed by a second axis and a third axis. According to two-dimensional horizontal coordinate of each two-dimensional layer, each two-dimensional layer is sequentially printed with a dot matrix line by line in the second axis direction.

Further, in above method, according to each two-dimensional layers of two-dimensional horizontal coordinates, a progressive dot matrix line by line printing step is performed on each two-dimensional layers along the second axis. The steps further include: step 1, a printing nozzle is moved to the first axis coordinate where the first level of two-dimensional layer is located. Step 2, all of the second axis coordinates for each third axis coordinate of the current two-dimensional level in the second axis direction is obtained and the printing nozzle is located on a first third coordinate of the current two-dimensional level, and a printing process is sequentially performed on the first third axis coordinate in each second axis coordinate of second axis direction. Step 3, the printing process of the last third axis coordinate of the current two-dimensional level in last second axis coordinate of the second axis direction is determined to complete or not, if it is, then step 5 is to be performed, otherwise, step 4 is to be performed. Step 4, the printing nozzle is moved to the next third axis coordinate of the current two-dimensional layer, the printing process is performed on current third axis coordinate in each second axis coordinate of the second axis direction. Step 5, the first axis coordinate of the current two-dimensional layer is determined to equal to the first axis coordinate of the last layer of two-dimensional layers, if it is, the printing nozzle is withdrawn, otherwise, the printing nozzle is moved to the first axis coordinate where the next layer of two-dimensional level is located and return to step 2.

Further, in above method, according to two-dimensional horizontal coordinate of each layer of two-dimensional layers, the dot matrix line by line printing process is performed on each two-dimensional layer along the second axis direction, and the process is performed on a plurality of rigid or soft bearing surfaces connected along the third axis direction.

Further, in above method, the rigid bearing surfaces are connected in a folding manner.

Further, in above method, one of the first axis, the second axis, and the third axis is selected from a group consisting of X-axis, Y-axis, and Z-axis.

Further, in above method, the first axis is Z-axis, and one of the second axis and the third axis is selected from a group consisting of X-axis and Y-axis.

In order to accomplish the above objects, the present invention further provides a three-dimensional object printing system. The system includes a three-dimensional modeling module to analyze and construct a three-dimensional model to be printed. A separating module is provided for separating the three-dimensional model into a plurality of two-dimensional layers along a first axis direction and to obtain the two-dimensional horizontal coordinates of each of the plurality of two-dimensional layers, in which the two-dimensional horizontal coordinates are composed of second axis and third axis. A printing control module is provided for dot matrix line by line printing sequentially in second axis direction for each two-dimensional layer according to the two-dimensional horizontal coordinates of each two-dimensional layer.

Further, in above system, the printing control module further includes a first axis coordinate control unit which is provided for moving the printing nozzle to the first axis coordinate where the two-dimensional layers is located. A first line printing control unit is provided for obtaining all of the second axis coordinates for each third axial coordinate of current two-dimensional layer in second axis direction and for locating the printing nozzle in the first third axis coordinate of the current two-dimensional layers, and the printing nozzle prints sequentially along the second axis direction for each second axis coordinate in the third axis coordinate. A third axis coordinate determining unit is provided for determining the printing for the last third axis coordinate of the current two-dimensional layer in each second axis coordinate of the second axis direction. A sequent line printing control unit is provided for moving the printing nozzle to the next third axis coordinate of the current two-dimensional layers, and sequentially printing along the current third axis coordinate in each second axis coordinate of the second axis direction. A first axis coordinate determining unit is provided for determining the first axis coordinate of the current two-dimensional layer is equalized to the first axis coordinate of the last two-dimensional layer.

Further, in above system, the printing control module further includes a plurality of rigid or soft bearing surfaces connected along the third axis direction.

Further, in above system, the rigid or soft bearing surfaces are connected in a folding manner.

Further, in above system, one of the first axis, the second axis, and the third axis is selected from a group consisting of X-axis, Y-axis, and Z-axis.

Further, in above system, the first axis is Z-axis, and one of the second axis and the third axis is selected from a group consisting of X-axis and Y-axis.

To compare with the present technology, the present invention analyzing and constructing a three-dimensional model of a work piece to be printed and separating the three-dimensional model along the first axis into the plurality of two-dimensional layers to obtain the two dimensional horizontal coordinates of the two dimensional layers which are composed of the second axis and the third axis. According to two dimensional horizontal coordinate of each two-dimensional layers, the dot matrix line by line printing is performed in second axis direction along each two-dimensional layers to overcome the printing limitation of the current three-dimensional printer to achieve the infinite printing of the three-dimensional single direction axial, and the structure of present three-dimensional printer with smaller volume does not have to be changed.

### BRIEF DESCRIPTION OF THE DRAWINGS

The present invention will be apparent to those skilled in the art by reading the following description of a preferred embodiment thereof with reference to the drawings, in which:

FIG. 1 is a cross-sectional view of showing work-piece in accordance with the present invention;

FIG. 2 a schematic view of showing direction and sequence of 3D objects printing in accordance with the present invention; ;

FIG. 3 is a flow chart of one embodiment of three-dimensional object printing in accordance with the present invention;

FIG. 4 is a flow chat of Step S3 of FIG. 3 in accordance with the present invention;

FIG. 5 is a schematic view of showing printing direction and sequence of one embodiment in accordance with the present invention;

FIG. 6 is a schematic view of showing a three-dimensional object printing system of one embodiment in accordance with the present invention; and

FIG. 7 is a schematic view of showing a printing control module in accordance with the present invention.

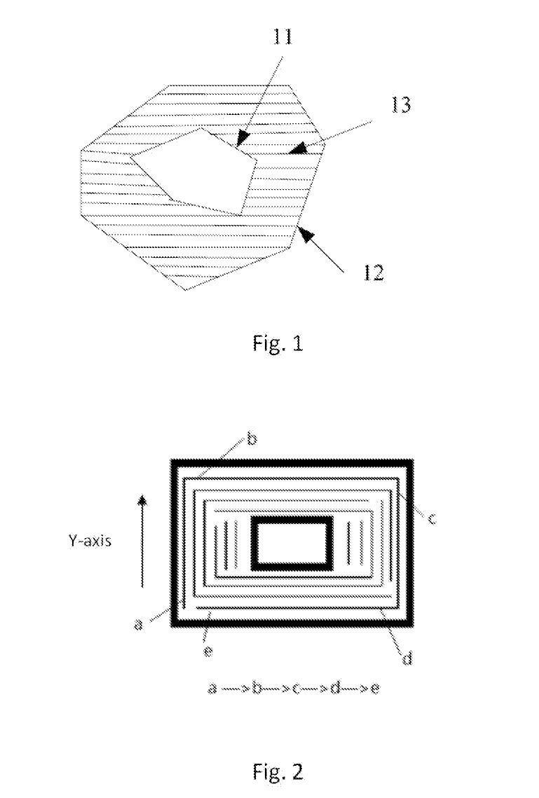

### DETAILED DESCRIPTION OF THE PREFERRED EMBODIMENT

In the following detailed description of the preferred embodiments, reference is made to the accompanying drawings which form a part hereof, and as shown by way of illustration specific embodiments in which the invention may be practiced. As such, the directional terminology is used for purposes of illustration and is in no way limiting the present invention.

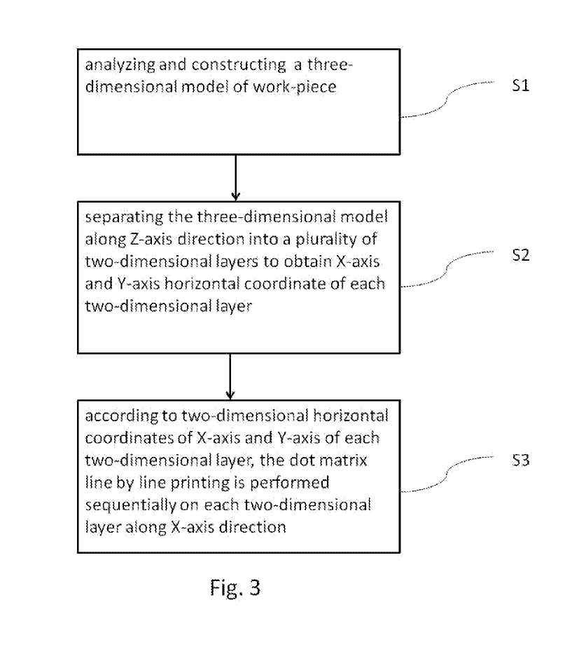

Following is an embodiment of the present invention, as shown in FIG. 3, the present invention provides a three-dimensional object printing method, which includes:

Step S1: a three-dimensional model of work-piece is analyzed and constructed.

Step S2: the three-dimensional model along Z-axis direction is separated into a plurality of two-dimensional layers to obtain X-axis and Y-axis horizontal coordinate of each two-dimensional layer. Specifically, the three-dimensional model is sliced along Z-axis direction in step S2.

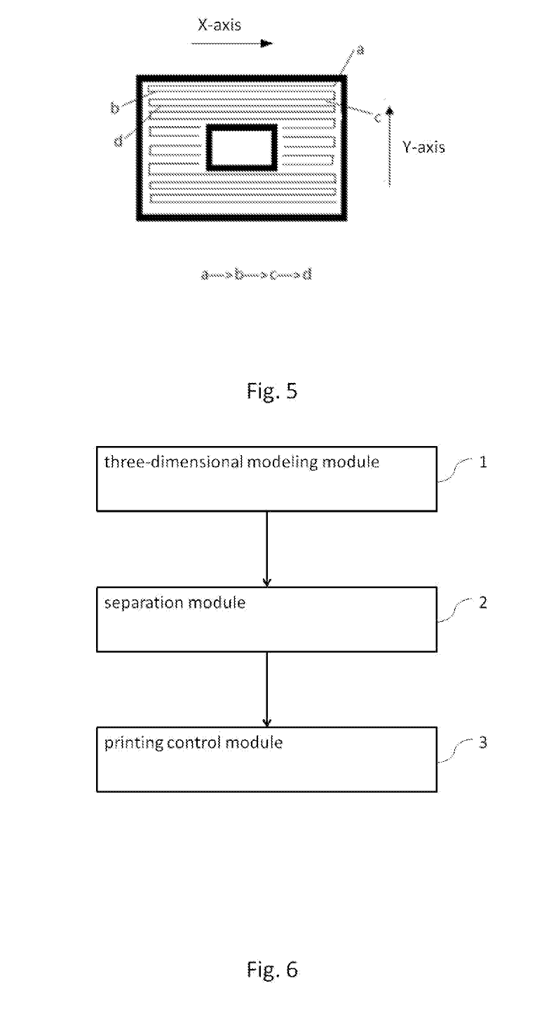

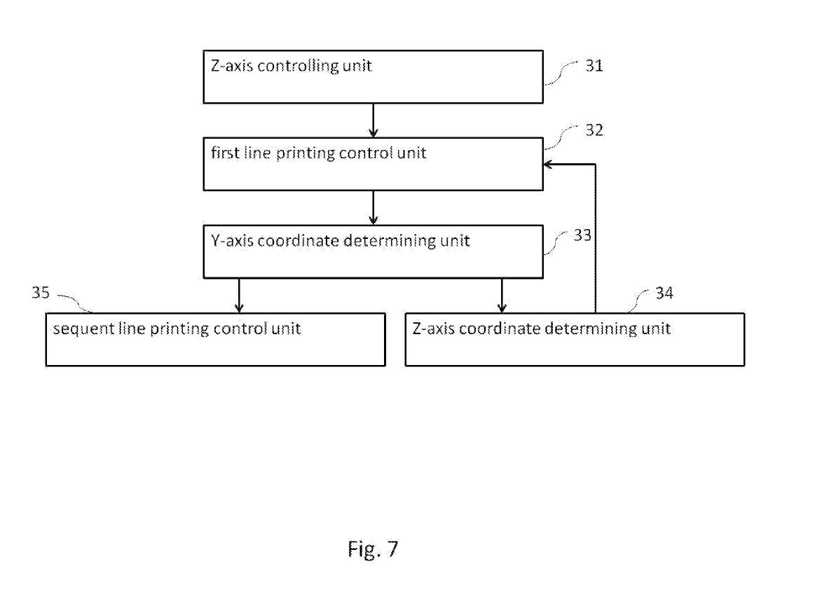

Step S3: according to two-dimensional horizontal coordinates of X-axis and Y-axis of each two-dimensional layer, the dot matrix line by line printing is performed sequentially on each two-dimensional layer along X-axis direction. Specifically, the present invention adjusts the printing sequence and direction of the three-dimensional printing and combines the conventional two-dimensional printing direction and sequence to achieve the infinite printing in single axis and the three-dimensional printer structure does not have to be changed. For example, the three-dimensional printing method of the present invention can apply for a three-dimensional scroll painting or other objects with special requirements in single-axis length. The printing nozzle performs printing process with dot matrix line by line printing along X-axis direction directly. After printing of one line is completed, the printing nozzle is moved along the Y-axis direction to next line and continues the printing. After printing of a layer is completed, the printing nozzle is moved along the Z-axis direction to the next layer and continues the printing. The embodiment of the present invention regards the printing of each layer as a single two-dimensional printing task, decomposes the two-dimensional layers into lines and to convert the linear motion into a lateral dot matrix as shown in FIG. 5. In FIG. 5, the printing sequence and the direction is from a, b, c, d, that is, the printing nozzle is moved on the x-axis direction, so that the printing range in y-axis is not limited by the printer size and space. To compare the printing sequence and direction of FIG. 2 with that of FIG. 5, it would be obvious that the printing direction and order of a conventional three-dimensional printer is a linear motion. The two-dimensional printing of the present invention is a dot matrix printing. The three-dimensional printer of the present embodiment merely requires a small fixed width in Y-axis direction for printing plane.

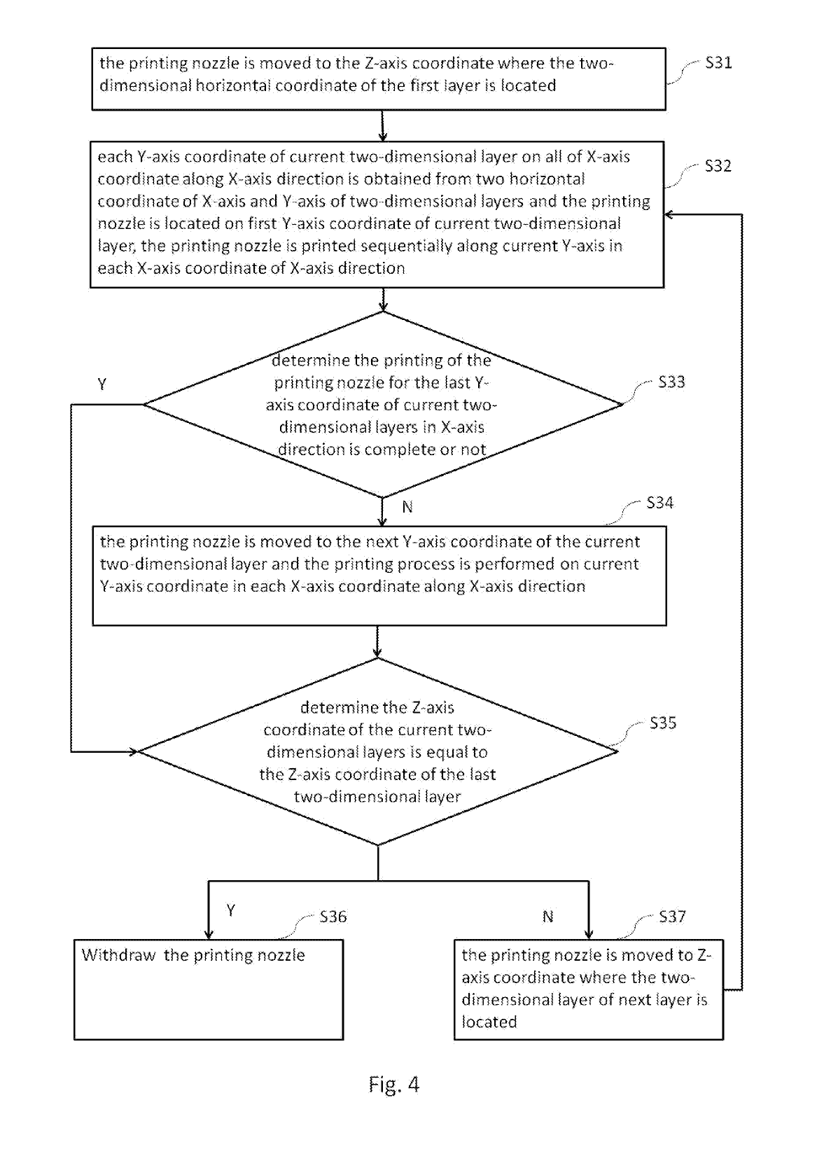

In one preferred embodiment, as shown in FIG. 4, the Step S3 further includes:

Ste S31: the printing nozzle is moved to the Z-axis coordinate where the two-dimensional horizontal coordinate of the first layer is located.

Step S32: each Y-axis coordinate of current two-dimensional layer on all of X-axis coordinate along X-axis direction is obtained from two horizontal coordinate of X-axis and Y-axis of two-dimensional layers and the printing nozzle is located on first Y-axis coordinate of current two-dimensional layer, the printing nozzle is printed sequentially along current Y-axis in each X-axis coordinate of X-axis direction.

Step S33, determine the printing of the printing nozzle for the last Y-axis coordinate of current two-dimensional layers in X-axis direction is complete or not, if it is, step S35 is to be performed, otherwise, step S34 is to be performed.

Step S34: the printing nozzle is moved to the next Y-axis coordinate of the current two-dimensional layer and the printing process is performed on current Y-axis coordinate in each X-axis coordinate along X-axis direction.

Step S35: determine the Z-axis coordinate of the current two-dimensional layers is equal to the Z-axis coordinate of the last two-dimensional layer, if it is, Step S36 is then performed, otherwise, Step S37 is then performed.

Step S36: the printing nozzle is withdrawn.

Step S37: the printing nozzle is moved to Z-axis coordinate where the two-dimensional layer of next layer is located, and Step S32 is then performed.

In one preferred embodiment, Step S3 is performed on a plurality of rigid bearing surfaces connected along Y-axis direction, in which the plurality of rigid surfaces in a folding manner, and the connection method is not limited in this invention. More specifically, a bearing surface is located on the bottom of the printed work-piece as two-dimensional printing ink is to rely on the paper as the bearing surface. The three-dimensional work piece also requires a bearing surface which can move forward and reverse along Y-axis direction. Since the three-dimensional printing material solidifies very fast, the material has certain rigidness and the printing length in Y-axis direction is depended upon the rigidness of the three-dimensional material itself and the model weight. The rigid bearing surface is in folding connection and the rigid bearing surface could be curved in storage state. The bearing surface is taken to remain flat in a straight direction, so that an infinite printing bearing surface can be provided in Y-axis direction.

The present invention can overcome the printing limitation for the three-dimensional printer to achieve the infinite printing for the three-dimensional model single direction, the present structure of the three-dimensional printer dose not have to be changed even the three-dimensional printer has smaller volume, so as to the volume of the three-dimensional printer could be designed smaller in the actual manufacturing for the three-dimensional printer.

Another prefer embodiment of the present invention provides a three-dimensional object printing system. As shown in FIG. 6, the three-dimensional object printing system includes a three-dimensional modeling module 1 that is provided for analyzing and constructing a three-dimensional model to be printed. A separation module 2 is provided for separating the three-dimensional model into a plurality of two-dimensional layers along the Z-axis direction to obtain two-dimensional horizontal coordinate of X-axis and Y-axis for each layer of two-dimensional layers. A printing control module 3 is provided for dot matrix line by line printing sequentially along X-axis direction for each two-dimensional layer.

In one preferred embodiment, the printing control module 3 includes a Z-axis controlling unit 31 which is provided for moving the printing nozzle to a Z-axis coordinate where the two-dimensional layers are located. A first line printing control unit 32 is provided for obtaining all of X-axis coordinate along X-axis direction for each Y-axis coordinate of the current two-dimensional layer from current X-axis and Y-axis of two-dimensional horizontal coordinates of the current two-dimensional layer, and after locating the printing nozzle in a first Y-axis coordinate of the current two-dimensional layer, the first line printing control unit 32 controls the printing nozzle to print in each X-axis coordinate along X-axis direction. A Y-axis coordinate determining unit 33 is provided for determining the printing completion of each X-axis coordinate in last Y-axis coordinate of the current two-dimensional layers along the X-axis direction. A sequent line printing control unit 35 is provided for moving the printing nozzle to the next Y-axis coordinate of the current two-dimensional layer and for printing in each X-axis coordinate along X-axis direction for the current Y-axis coordinate. A Z-axis coordinate determining unit 34 is provided for determining the Z-axis coordinate of current two-dimensional layer is equal to the X-axis coordinate of two-dimensional layers of the last layers.

In one preferred embodiment, the printing control module 3 further includes a plurality of rigid bearing surfaces connected along Y-axis direction, in which the plurality of rigid bearing surfaces is connected in folding manner. The special details of the implementation can be found in first embodiment and it is not to be described herein.

In summary, the present invention analyzes and constructs the three-dimensional model which is to be printed and separates the three-dimensional model into a plurality of two-dimensional layers along Z-axis direction to obtain two-dimensional horizontal coordinates of X-axis and Y-axis for each two-dimensional layer. According to two-dimensional horizontal coordinate of X-axis and Y-axis of each two-dimensional layer, the dot matrix line by line printing is sequentially performed on each two-dimensional layer along X-axis direction to overcome the printing limitation of the present three-dimensional printer to achieve the infinite printing of three-dimensional model in single direction so as to the present three-dimensional printer structure does not have to be changed even three-dimensional printer with smaller volume.

The various embodiments of the present specification utilizes the progressive manner, the description of each the embodiments are described is differs from the other embodiments and each embodiments refer to the same or similar parts to each other. The system of the present embodiment is corresponding to the implementation manner, and thus the description of the system is relatively simple, and the relevant instruction for the system is referred to the embodiment for the manner of the present invention.

The professionals can further realize the combination the example and algorithm steps which is capable of combining the electronic hardware, computer software, or a combination of both. In order to clearly illustrate the hardware and software interchangeability, the aforementioned description has been generally described and the composition of each steps in the example functions. These functions exactly to the hardware or software methods to execute which is depending on the particular application and design constraints of technology solutions. The professional and technical person can use different manner for each specific application to implement the function of description, but it should not be considered to achieve beyond the scope of the present invention.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A three-dimensional object printing method, comprising:
analyzing a three-dimensional model to be printed;
separating the three-dimensional model into a plurality of two-dimensional layers along a first axis to obtain a two dimensional horizontal coordinate of each of the two-dimensional layers, wherein the two-dimensional horizontal coordinate is composed of a second axis and a third axis; and
sequentially doing line-by-line dot-matrix printing along the second axis for each of the two-dimensional layers according to the two-dimensional horizontal coordinate of each of the two-dimensional layers.

2. The printing method of claim 1, wherein the step of sequentially doing line-by-line dot-matrix printing along the second axis for each of the two-dimensional layers according to the two-dimensional horizontal coordinate of each of the two-dimensional layers comprise the following steps:
step 1: moving a printing nozzle along the first axis to a coordinate on which a first layer of the two-dimensional layers is located;
step 2: obtaining all of the second axis coordinates for each of the third axial coordinates of the first layer according to the two-dimensional horizontal coordinate of the first layer, locating the printing nozzle on a first third coordinate of the first layer, and sequentially doing printing along the second axis for all of the second coordinates in the first third coordinate;
step 3: determining whether a printing along the second axis for a last second coordinate in a last third coordinate is completed, if yes then go to step 5 otherwise go to step 4;
step 4: moving the printing nozzle to a third coordinate next to the first third coordinate of the first layer, and sequentially doing printing along the second axis for all of second coordinates in the third coordinate; and
step 5: determining whether the first axis coordinate of the present two-dimensional layer is where the last two-dimensional layer locates, if yes then withdraw the printing nozzle, otherwise moving the printing nozzle to the first coordinate on which the next two-dimensional layer is located and then going to step 2.

3. The printing method of claim 1, wherein the step of sequentially doing line-by-line dot-matrix printing along the second axis for each of the two-dimensional layers according to the two-dimensional horizontal coordinate of each of the two-dimensional layers is performed on a plurality of rigid or soft bearing surfaces connected along the third axis direction.

4. The printing method of claim 3, wherein the rigid or soft bearing surfaces are connected in a folding manner.

5. The printing method of claims 1, wherein one of the first axis, the second axis, and the third axis is selected from a group consisting of X-axis, Y-axis, and Z-axis.

6. The printing method of claim 5, wherein the first axis is Z-axis, and one of the second axis and the third axis is selected from a group consisting of X-axis and Y-axis.

7. A three-dimensional object printing system, comprising:
a three-dimensional modeling module to analyze and construct a three-dimensional model to be printed;
a separating module to separate the three-dimensional model into a plurality of two-dimensional layers along a first axis and to obtain a two dimensional horizontal coordinate of each of the two-dimensional layers, wherein the two-dimensional horizontal coordinate is composed of a second axis and a third axis; and
a printing control module to sequentially do line-by-line dot-matrix printing along the second axis for each of the two-dimensional layers according to the two-dimensional horizontal coordinate of each of the two-dimensional layers.

8. The system of claim 7, wherein the printing control module comprises:
a first axis coordinate control unit to move a printing nozzle along the first axis to a coordinate on which the two-dimensional layers are located;
a first line printing control unit to obtain all of the second axis coordinates for each of the third axial coordinates of a present two-dimensional layer according to the two-dimensional horizontal coordinate of the present two-dimensional layer, and locate the printing nozzle on a first third coordinate of the first layer, and sequentially do printing along the second axis for all of the second coordinates in the first third coordinate;
a third axis coordinate determining unit to determine whether the printing nozzle completes a printing along the second axis for a last second coordinate in a last third coordinate;
a sequent line printing control unit to move the printing nozzle to a third coordinate next to the first third coordinate of the present two-dimensional layer, and sequentially do printing along the second axis for all of second coordinates on the third coordinate; and
a first axis coordinate determining unit to determine whether the first axis coordinate of the present two-dimensional layer is where the last two-dimensional layer locates.

9. The system of claim 7, further comprising: a plurality of rigid or soft bearing surfaces connected along the third axis direction.

10. The system of claim 9, wherein the rigid or soft bearing surfaces are connected in a folding manner.

11. The system of claims 7, wherein one of the first axis, the second axis, and the third axis is selected from a group consisting of X-axis, Y-axis, and Z-axis.

12. The system of claim 11, wherein the first axis is Z-axis, and one of the second axis and the third axis is selected from a group consisting of X-axis and Y-axis.
